(19) United States
(12) Patent Application Publication
(10) Pub. No.: US 2023/0252484 A1
(43) Pub. Date: Aug. 10, 2023

(54) SYSTEMS AND METHODS FOR ORCHESTRATING AUTOMATED CONTENT DISTRIBUTION TO ENCOURAGE DIGITAL ADOPTION

(71) Applicant: Capital One Services, LLC, McLean, VA (US)

(72) Inventors: Margaret Crouse, Burke, VA (US); Michael Mossoba, Great Falls, VA (US); Joanna Rees Snead, Oakton, VA (US); Lesley Newton, Richmond, VA (US); Dagmawit Metty Fisseha, Washington, DC (US); Kelly Morse Kornman, Mechanicsville, VA (US)

(21) Appl. No.: 17/666,929

(22) Filed: Feb. 8, 2022

(51) Int. Cl. G06Q 30/00; G06Q 30/02; G06Q 10/06

(52) U.S. Cl. CPC G06Q 30/016; G06Q 30/0204; G06Q 10/06315

(57) ABSTRACT

The disclosed technology relates to improved content deployment and orchestration to more effectively convert customers or users to paperless communication channels and facilitate increased digital engagement. An exemplary system may obtain user context data associated with a user following a trigger event. The system may then apply a trained machine learning model to the user context data to generate a likelihood score. The likelihood score may be indicative of a likelihood the user will enroll in a particular delivery option (e.g., paperless delivery) following the trigger event. Responsive to determining the likelihood score exceeds a threshold, the system may output content to the second user that may be identified based on a type of the trigger event and may be targeted to encourage enrollment in the delivery option. In addition to outputting the content, the system may be configured to establish orchestration for subsequent automated content delivery for the user.

### FIELD

The disclosed technology relates to systems and methods for digital content distribution, and more particularly to improved digital content orchestration with sequencing and deployment parameters determined using machine learning.

### BACKGROUND

Service providers and other digital platform hosts are often faced with the problem of limited customer enrollment in paperless communication channels. For example, financial institutions generally communicate regular (e.g., monthly) statements to customers regarding their savings or credit accounts. These statements can be communicated electronically to customers that have enrolled in paperless delivery but are otherwise mailed to a subset of customers that have yet to enroll in a paperless delivery option. The physical mailing of communications is costly for the service providers and there are significant downstream benefits to increased digital adoption.

In particular, customers enrolled in paperless delivery options tend to have a digital-first approach with better engagement with digital tools, such as mobile and web applications hosted by service providers, and tend to be more self-sufficient via digital functions, resulting in fewer helpdesk contacts for assistance. Customers enrolled in paperless delivery services may also receive an improved billing experience and may be more likely to pay on time via automated, scheduled payments and electronic payment channels. Customers and other types of platform users that have better engagement may be relatively loyal and may use a broader scope of services available via digital channels.

However, facilitating enrollment in digital communication options can be challenging. Determining parameters (e.g., when and how) of presenting a selectable option to enroll in paperless delivery, or content advertising benefits of paperless delivery, for example, in a manner that achieves a business goal, is currently difficult and ineffective for service providers. Accordingly, there is a need for improved content orchestration systems that are capable of determining optimal approaches (e.g., timing, type of distribution channel, etc.) to presenting enrollment options and other messaging content in order to yield increased enrollment and digital adoption.

### BRIEF SUMMARY

Aspects of the disclosed technology include systems and methods for orchestrating the sequencing, channel, and other parameters associated with delivering content to encourage customer or user enrollment in digital or paperless communication. The content orchestration is improved in some examples by training and deploying a machine learning model based on enrollment context data and the likelihood that a user will engage deployed content to achieve a business goal (e.g., enroll in paperless delivery). Responsive to trigger events, unenrolled users can be targeted with output content that encourages enrollment that is identified based on a type of the trigger event. In some examples, content delivery is orchestrated to establish a sequence of content delivery for particular users that is active until a user enrolls or the trigger events associated with the sequence are exhausted, for example. By more effectively targeting content to increase paperless delivery enrollment, for example, this technology improves digital engagement and brand loyalty, among other downstream benefits.

The disclosed technology includes an orchestration system for content distribution that includes one or more processors and memory in communication with the one or more processors and storing instructions that, when executed by the one or more processors, are configured to cause the system to perform one or more methods. For example, responsive to detecting an enrollment event based on an input received from a first user computing device, the system may retrieve enrollment context data associated with a first user of the first user computing device. The system may then update a machine learning model based on the enrollment context data. Responsive to detecting a trigger event associated with a second user, a determination may be made as to whether the second user is enrolled in a delivery option based on stored enrollment option data associated with the second user. Responsive to determining the second user is not enrolled in the delivery option, the system may obtain user context data associated with the second user. The system may then apply the machine learning model to the user context data to generate a likelihood score. The likelihood score may be indicative of a likelihood the second user will enroll in the delivery option following the trigger event. Responsive to determining the likelihood score exceeds a threshold, the system may output first content to the second user. The first content may be identified based on a type of the trigger event.

The disclosed technology includes another orchestration system for content distribution that includes one or more processors and memory in communication with the one or more processors and storing instructions that, when executed by the one or more processors, are configured to cause the system to perform one or more methods. For example, responsive to detecting a trigger event associated with a first user, the system may determine whether the first user is enrolled in a delivery option based on stored enrollment option data associated with the first user. Responsive to determining the first user is not enrolled in the delivery option, the system may obtain user context data associated with the first user. The system may then apply a stored machine learning model to the user context data to generate orchestration data defining a delivery sequence for automated output of first content following subsequent trigger events associated with the first user. The first content may be targeted to encourage enrollment in the delivery option in some examples. Additionally, the system may store the orchestration data associated with the first user to facilitate subsequent content delivery.

The disclosed technology includes yet another orchestration system for content distribution that includes one or more processors and memory in communication with the one or more processors and storing instructions that, when executed by the one or more processors, are configured to cause the system to perform one or more methods. For example, responsive to detecting a trigger event associated with a first user, the system may determine whether the first user is enrolled in a delivery option based on stored enrollment option data associated with the first user. Responsive to determining the first user is not enrolled in the delivery option, the system may obtain user context data associated with the first user. The system may then apply a stored machine learning model to the user context data to generate a likelihood score. The likelihood score may be indicative of a likelihood the first user will enroll in the delivery option following the trigger event. Responsive to determining the likelihood score exceeds a threshold, the system may output first content to the first user. The first content may be selected based on a type of the trigger event.

Other embodiments, features, and aspects of the disclosed technology are described in detail herein and are considered a part of the claimed disclosed technologies. Other embodiments, features, and aspects can be understood with reference to the following detailed description, accompanying drawings, and claims.

### BRIEF DESCRIPTION OF THE DRAWINGS

FIG. 1 is a flow diagram of an example method 100 for training a machine learning model 460 based on enrollment context data following detection of enrollment events, in accordance with an exemplary embodiment of the disclosed technology.

FIG. 2 is a flow diagram of an example method 200 for distributing content, and optionally establishing content orchestration, based on trigger events and the application of a trained machine learning model 460, in accordance with another exemplary embodiment of the disclosed technology.

FIG. 3 is a block diagram of a network environment 400 that includes a service provider system 330, including an orchestration system 310, according to certain exemplary implementations of the disclosed technology.

FIG. 4 is a block diagram of an orchestration system 310 according to an exemplary implementation of the disclosed technology.

### DETAILED DESCRIPTION

Certain implementations of the disclosed technology may be utilized to automatically orchestrate the delivery of content to facilitate improved enrollment in paperless communication options. A machine learning model 460 is trained based on enrollment context data for users and used to correlate and determine parameters associated with digital content deployment that can be used following trigger events for users. The machine learning model 460 can be deployed in a service provider system 330 and applied following a marketing trigger event, such as a login via a web or mobile application by a user or generation of a statement for a user, for example. If a trigger event occurs for an unenrolled user for which orchestration has previously been established, then the service provider system 330 can determine whether the trigger event is next in the orchestrated sequence for the user, in which case targeted content corresponding to the type of the trigger event is output to encourage enrollment. For example, if the next trigger event in the sequence is a web application login, the targeted content can be a banner advertisement clickable to transition a user to a webpage facilitating enrollment in paperless delivery.

When orchestration has not been established for a user, the service provider system 330 obtains user context data and applies the machine learning model 460 to the user context data to facilitate a correlation with the enrollment context training data and determine a likelihood that deployment of content in response to the trigger event will achieve the business goal (e.g., enrollment by the user in paperless delivery). If the service provider system determines that the likelihood exceeds a threshold, then targeted content is identified and output. For example, if the application of the machine learning model 460 to demographic data in the user context data indicates a likelihood score exceeding a threshold, a quick response (QR) code can be printed on a statement in response to a statement generation trigger event, with the QR code configured to, when captured, link a mobile device to a webpage facilitating enrollment in paperless delivery.

As will be described and illustrated in more detail below, since multiple exposures to requests to enroll may increase the likelihood that the business goal is achieved, orchestration of content deployment can be established in some examples. To establish orchestration, the service provider system 330 stores an indication of the user as associated with multiple trigger events. When those trigger events occur for the user, the content associated with the type of the trigger event is automatically output without application of the machine learning model 460. In some examples, the content deployment can be orchestrated irrespective of the trigger events that are analyzed by the service provider system 330 to allow for output of the content via additional communication channels.

By leveraging machine learning to selectively target and deploy content, the service provider device 330 may facilitate increased digital adoption and paperless enrollment. Content encouraging or offering selection of paperless delivery enrollment can be deployed in an improved manner with this technology, including via orchestration and sequencing, to improve engagement with the content and associated paperless enrollment. Accordingly, implementations of the disclosed technology provide a more effective marketing and digital adoption strategy for increased paperless delivery enrollment and improved digital engagement and brand loyalty for service providers (e.g., financial service providers).

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Reference will now be made in detail to exemplary embodiments of the disclosed technology, examples of which are illustrated in the accompanying drawings and disclosed herein. Wherever convenient, the same reference numbers will be used throughout the drawings to refer to the same or like parts.

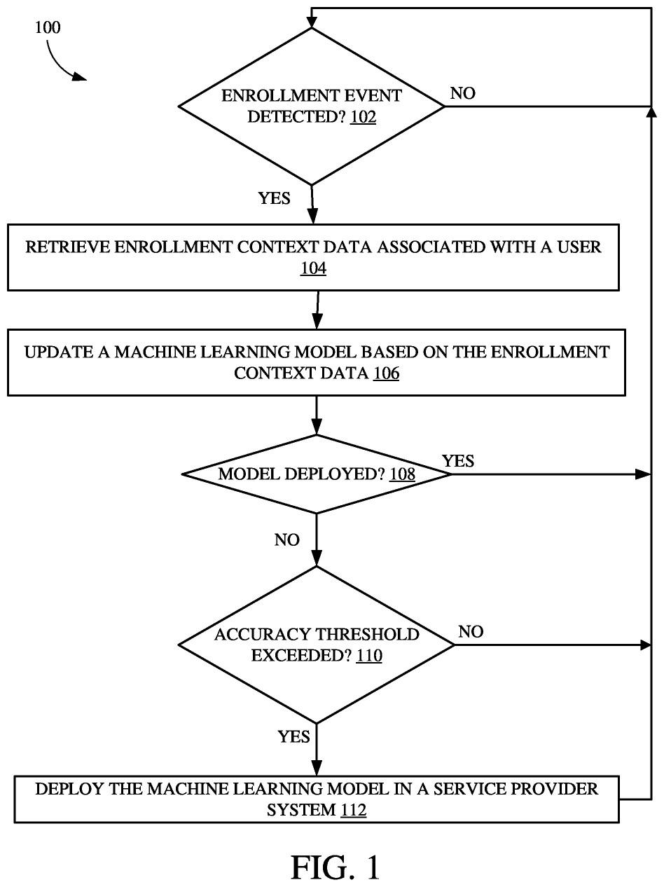

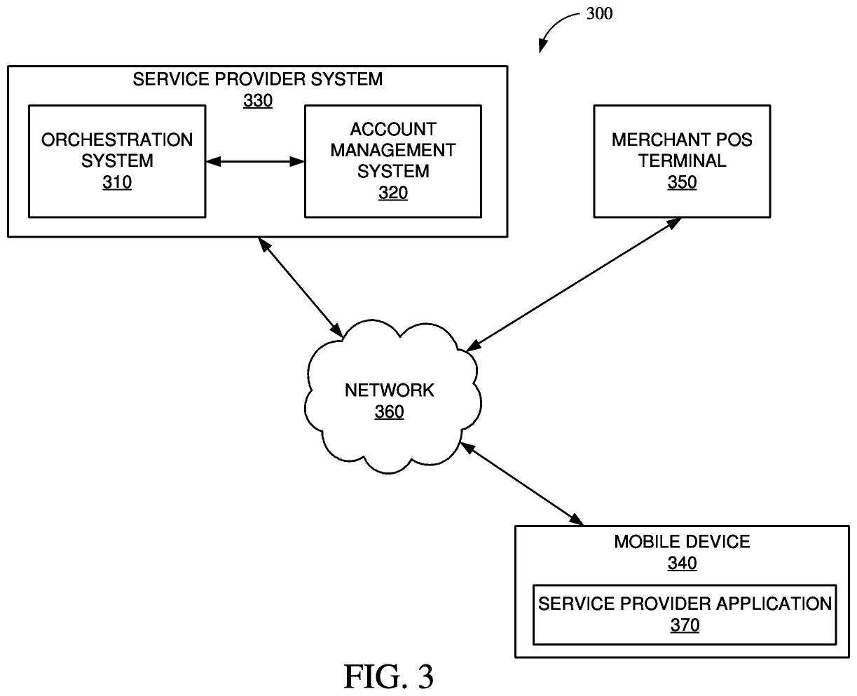

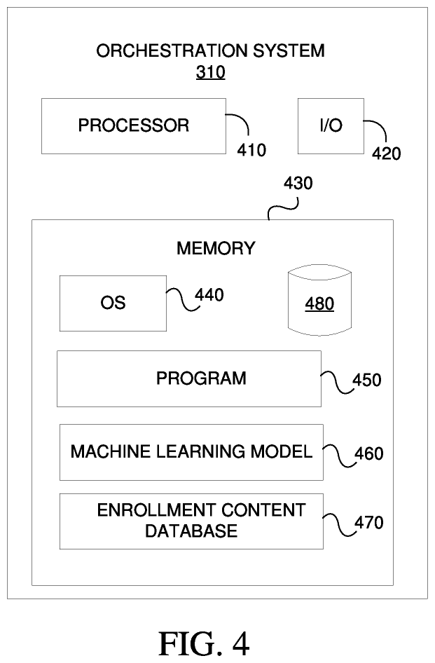

FIG. 1 is a flow diagram of an example method 100 for training a machine learning model 460 based on enrollment context data following detection of enrollment events, in accordance with an exemplary embodiment of the disclosed technology. Method 100 may be performed by a system (e.g., a service provider system 330 and/or one or more subsystems thereof, such as an orchestration system 310, as described in more detail with respect to FIGS. 3-4). The system includes one or more processors and memory in communication with the one or more processors and storing instructions. When executed by the one or more processors, the stored instructions cause the system to perform certain functions, such as one or more steps described and illustrated herein with reference to method 100 and/or method 200.

In block 102, the system may determine whether an enrollment event has been detected for a user (e.g., a customer of a service provider such as a financial institution). The enrollment event can be a request to enroll in paperless delivery of bank account statements, for example, although other types of enrollment events can be detected in other examples. The system can monitor a device (e.g., account management system 320) to determine when an enrollment event is initiated at that device. In another example, the system can periodically scan a database (e.g., customer information database 480) to identify updated enrollment data for a user that indicates that an enrollment event has occurred for the user since a previous database scan. Other methods for detecting enrollment events can also be used in other examples. If the system determines that an enrollment event has not been detected for at least one user, then the No branch is taken back to block 102 and the system effectively waits to detect an enrollment event. However, if the system determines in block 102 that an enrollment event has been detected for at least one user, then the Yes branch is taken to block 104.

In block 104, the system may retrieve enrollment context data associated with a user. One or more portions of the enrollment context data can be obtained from a database of user information (e.g., customer information database 480), including enrollment status, and/or can be generated by the system contemporaneously with respect to the detected enrollment event. The enrollment context data can include information relating to the detected enrollment event that can facilitate correlation and pattern identification for subsequent enrollment events. For example, the enrollment context data can include user context data for the user (e.g., demographic data), previous bill payment method (e.g., phone or online), purchase transaction history (e.g., cadence, amount, or merchants), a type of trigger event(s) that preceded the enrollment event (e.g., mailing of a paper statement), a time, date, or day of the week of the enrollment event, or a cadence of trigger events for the user that preceded the enrollment event. In other examples, the enrollment context data can be obtained from third party or external devices or servers and can include recent weather or geographical events in proximity of the user associated with the enrollment event, for example.

In block 106, the system may update a stored machine learning model 460 based on the enrollment context data. In this example, the machine learning model 460 is trained by analyzing trends and patterns for users that organically (e.g., without targeted marking or other prompting by the system) enroll (e.g., in paperless statement delivery) and for which enrollment events are detected in block 102. For example, the machine learning model 460 may determine over time and during its training that users that typical pay bills online, shop at a certain eco-friendly retailer, and are under a certain age are relatively likely to enroll in paperless delivery when presented with an opportunity to do so in response to a web application login type of trigger event.

The supervised training in some examples can use a neural network training algorithm while the machine learning model 460 is offline before being deployed in the system and/or subsequent to deployment in order to continually improve accuracy. Accordingly, the system may utilize deep learning models, such as a convolutional neural network (CNN) or long short-term memory (LS™), for example. In other examples, the machine learning model 460 may be a binary classifier, such as a Support Vector Machine (SVM), Logistic Regression, Random Forest, or XGBoost, for example, and other types of machine learning models can also be used in other examples.

In block 108, the system may determine whether the machine learning model 460 has already been deployed in the system. Accordingly, in this example, the machine learning model 460 is continually trained to improve accuracy and may have been previously deployed in the system when the enrollment event is detected in block 102. If the system determines that the machine learning model 460 has been deployed, then the Yes branch is taken back to block 102, and the system does not evaluate the accuracy of the machine learning model 460 for deployment. However, if the system determines in block 108 that the machine learning model 460 has not yet been deployed, then the No branch is taken to block 110.

In block 110, the system may determine whether an accuracy threshold for the machine learning model 460 has been exceeded. In some examples, the system can automatically analyze the accuracy of the machine learning model 460 based on a database of synthetic trigger events and associated likelihood of enrollment. In these examples, the accuracy of the machine learning model 460 can be based on a ratio of the number of correct predictions to the total number of input samples, with the ratio or percentage being configurable according to a desired tolerance. For example, the system may apply the machine learning model 460 to 50 synthetic trigger events predefined to yield an enrollment likelihood over 50%. If the machine learning model 460 correctly predicts 45 of the 50 trigger events to be more likely than not to result in an enrollment if the user associated with the trigger event is presented content prompting such enrollment, then the accuracy ratio is 90%, which can be compared against the configurable accuracy threshold to determine whether the machine learning model 460 is ready for deployment.

In other examples, other predefined likelihood scores, number of synthetic trigger events, and/or methods for analyzing accuracy can also be used. For example, logarithmic loss, confusion matrix, F1 score, mean absolute error, and/or mean squared error methods can also be used to evaluate accuracy in other examples. If the system determines in block 110 that the accuracy of the machine learning model 460 does not exceed the accuracy threshold, then the No branch is taken back to block 102 and the system continues training the machine learning model 460. However, if the system determines in block 110 that the accuracy threshold has been exceeded, then the Yes branch is taken to block 112.

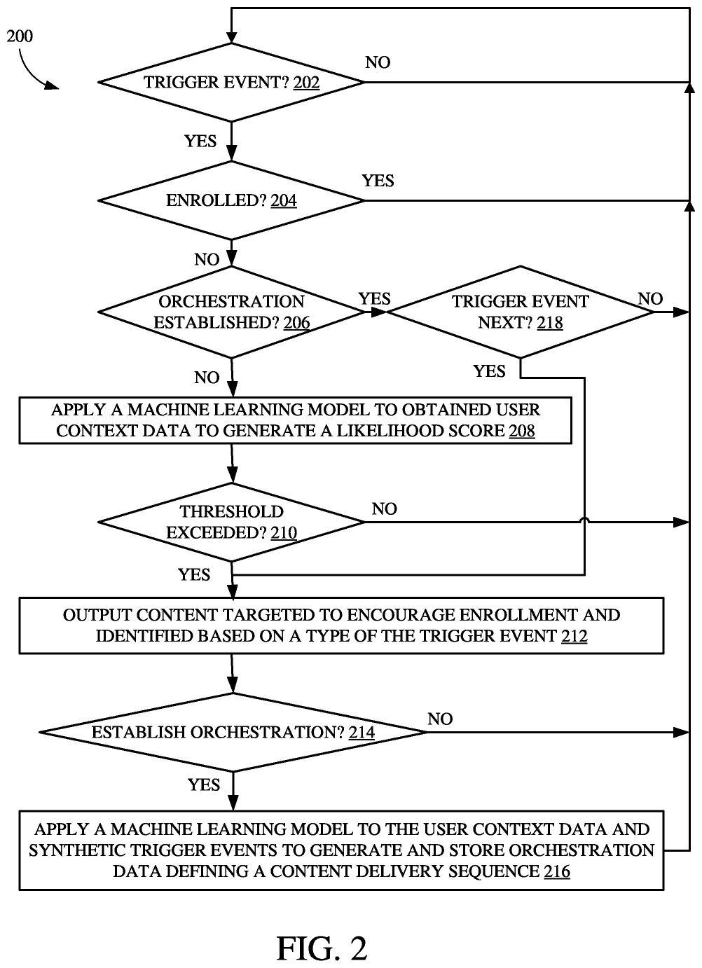

In block 112, the system may deploy the machine learning model 460, such as in the service provider system 330, for example. Accordingly, the deployed machine learning model 460 in this example is sufficiently trained to satisfy an accuracy threshold and will yield relatively accurate predictions that may improve the ability of the system to enroll a user in a paperless delivery option. The trained and deployed machine learning model 460 can be used by the system and described and illustrated below with reference to block 208 of FIG. 2, for example. Subsequent to deploying the machine learning model 460, the system can proceed back to block 102 and continue training to improve accuracy. In other examples, the system can discontinue the training subsequent to deployment. In yet other examples, the accuracy of the machine learning model 460 can be periodically tested using different input data and, if the accuracy falls below the accuracy threshold, the system can reinitiate the training.

In FIG. 2, a flow diagram is illustrated of an example method 200 for distributing content, and optionally establishing content orchestration, based on trigger events and the application of a trained machine learning model 460, in accordance with another exemplary embodiment of the disclosed technology. Method 200 may be performed by a system (e.g., an service provider system 330 and/or one or more subsystems thereof, such as an orchestration system 310, as described in more detail with respect to FIGS. 3-4). The system includes one or more processors and memory in communication with the one or more processors and storing instructions. When executed by the one or more processors, the stored instructions cause the system to perform certain functions, such as one or more steps described and illustrated herein with reference to method 200.

In block 202, the system may determine whether a trigger event has occurred for at least one user. The trigger event in some examples may be a successful login via mobile or web application, an incoming phone call, or generation of a statement (e.g., a savings or credit account statement), although other types of trigger events can also be monitored in other examples. The trigger event in some examples is any event associated with a user that is a marketing opportunity for presenting marketing content to a user to encourage enrollment (e.g., in a paperless delivery option).

Accordingly, in some examples, the system can itself be, or can be integrated with, a marketing device that automatically places and deploys digital content following trigger events. In these examples, the system may be configured to monitor for the occurrence of a trigger event at the system or another networked device, or can be queried by such networked device for content to present to a user associated with the trigger event. If the system determines that a trigger event has not occurred, then the No branch is taken back to block 202 and the system effectively waits to detect a trigger event. However, if the system determines in block 202 that a trigger event has occurred for at least one user, then the Yes branch is taken to block 204.

In block 204, the system may determine whether the user associated with the trigger event is already enrolled, such as in paperless statement delivery for example. The determination in block 204 can be based on a query to the customer information database 480 using a unique identifier of the user (e.g., a user name extracted from the login request in examples in which the trigger event is a web application login). If the system determines in block 204 that the user is already enrolled, then the Yes branch is taken back to block 202 and the system continues monitoring for trigger events. Optionally, the system can provide default or other selected content for deployment (e.g., placement in a banner graphic of a webpage served following the login request in the above example) that may advertise different services offered by the service provider, for example. However, if the system determines in block 204 that the user associated with the trigger event is not currently enrolled, then the No branch is taken to block 206.

In block 206, the system may determine whether orchestration has been established for the user. If automatic content delivery has been orchestrated for the user, then the parameters associated with content distribution, if any, following the trigger event are already stored, such as in the customer information database 480, as explained in more detail below with reference to block 216. The system can determine whether orchestration has been established based on a flag or other indicator associated with a unique identifier for the user in the customer information database 480, for example, although other methods for determining whether orchestration has been established for the user can also be used in other examples. If the system determines in block 206 that orchestration has not been established for the user, then the No branch is taken to block 208.

In block 208, the system may apply a machine learning model 460 to obtain user context data and a type of the trigger event detected in block 202 to generate a likelihood score. The applied machine learning model 460 can be generated and deployed as described and illustrated in detail above with reference to FIG. 1. The user context data can be obtained from the customer information database 480 based on a unique identifier for the user and can include demographic data, historical or forecasted event data, historical statement data, transaction or purchase history data, payment history data, or any other data that can be correlated with the enrollment context data used to train the machine learning model 460.

The machine learning model 460 can be configured to use a distance metric in some examples, such as a cosine similarity, Euclidean, hamming, Manhattan, Chebyshev, or Minkowski technique, for analyzing the user context data, with the likelihood score generated based on the distance metric, although the likelihood score can be generated in other ways in other examples. The likelihood score can be indicative of a likelihood that the user will enroll in paperless (e.g., via e-mail or web/mobile application) delivery of communication (e.g., financial statements) responsive to the trigger event detected in block 202. Although binary values and other types of likelihood scores can also be used in other examples.

In block 210, the system may determine whether the likelihood score generated in block 208 exceeds a threshold likelihood value. In some examples, the threshold can be 50% such that the condition in block 210 is satisfied when the likelihood score generated in block 208 indicates it is more likely than not that the user will enroll in the paperless delivery option responsive to the trigger event. Other threshold likelihood values can be used in other examples. If the system determines in block 210 that the threshold likelihood value is not exceeded, then the No branch is taken back to block 202. Optionally, the system can serve default or other content more likely to achieve a business goal with respect to the user for output to the user in response to the trigger event. However, if the system determines in block 210 that the threshold likelihood value is exceeded, then the Yes branch is taken to block 212.

In block 212, the system may output content targeted to encourage enrollment in the paperless delivery option. Optionally, the targeted content can be retrieved from the enrollment content database 470, although the targeted content can be retrieved from other sources in other examples. In some examples, the targeted content can be based on a type of the trigger event. For example, if the type of the trigger event is a web application login, the targeted content can be a banner graphic capable of insertion into a graphical user interface output for display after the web application login. The graphic can have an associated hyperlink in the graphical user interface configured to transition the graphical user interface to another webpage when selected by a user. The linked webpage can be configured to facilitate an enrollment by the user.

In another example, the type of the trigger event may be a helpdesk phone call and the targeted content can be a prerecorded message encouraging, and providing instructions for, enrollment. The prerecorded message can be output as part of a hold message of an interactive voice response (IVR) automated phone system. In yet another example, the type of the trigger event may be an initiation of the printing of a financial statement for subsequent physical mail distribution to the user. In this example, the targeted content can be a graphic including text for encouraging enrollment, or a QR code that encodes a link to an enrollment webpage, for example, that can be printed on the statement prior to distribution to the user. In other examples, other types of trigger events and/or targeted content can be used.

In block 214, the system may determine whether to establish orchestration for the user. The determination in block 214 can be based on any number of factors including a likelihood score generated in block 208 that exceeds the threshold likelihood value but is otherwise relatively low, any combination of the user context data obtained in block 208, a default configurable setting, an output of the application of the machine learning model 460 that indicates a particular sequence of targeted content delivery is likely to yield an enrollment for the user, or any other factor(s).

If the system determines in block 214 that orchestration should not be established for the user, then the No branch is taken back to block 202. If the No branch is taken from block 214, then the system will perform steps 204-214 in a subsequent iteration responsive to detection of a trigger event for the user in block 202. However, if the system determines in block 214 that orchestration should be established for the user, then the Yes branch is taken to block 216.

In block 216, the system may apply the machine learning model 460 to the user context data and synthetic trigger event(s) to generate and store orchestration data defining a content delivery sequence for the user. The orchestration data can be stored in the customer information database 480, for example. The synthetic trigger event(s) can correspond to all or a subset of the trigger events that are evaluated in the condition of block 202. The defined content delivery sequence can be based on the likelihood scores generated based on the application of the machine learning model 460 to the user context data and synthetic trigger event(s).

For example, the system may apply the machine learning model 460 to the user context data and each of paper statement generation, successful mobile application login, and incoming helpdesk call types of trigger events to generate likelihood scores. The content delivery sequence can then be defined by the system based on a ranking of the likelihood scores such that the trigger event with the highest likelihood score will be first in the sequence etc. If the next detected trigger event for the user is not the type of trigger event associated with the highest likelihood score, then default or other content that may be more likely to achieve a business goal can be output by the system, for example. Accordingly, the orchestration data stored in block 216 includes a content delivery sequence defining content for automated output following subsequent trigger events associated with the user. Subsequent to storing the orchestration data, the system proceeds back to block 202 in this example.

Referring back to block 206, if the system determines in another iteration that orchestration has been established for the user associated with the trigger event detected in block 202 (e.g., based on orchestration data stored for the user as described with reference to block 216), then the Yes branch is taken to block 218. In block 218, the system may determine whether the type of the trigger event detected in block 202 corresponds with an indication of the next trigger event defined in the content delivery sequence in the orchestration data stored for the user (e.g., in the customer information database 480). If the system determines in block 218 that the type of the trigger event is not the next trigger event in the content delivery sequence, then the No branch is taken back to block 202. Optionally, default or other content can then be provided for output to the user.

However, if the system determines in block 218 that the type of the trigger event corresponds with the next trigger event in the content delivery sequence defined for the user, then the Yes branch is taken to block 212. In block 212, the system may output targeted content as described and illustrated in more detail above.

Additionally, in this iteration, the system may update the orchestration data stored for the user to indicate that the next trigger event for the user has occurred to facilitate an accurate evaluation in a subsequent iteration of block 218. Accordingly, in this iteration, the system can avoid the application of the machine learning model 460 in block 208 and more efficiently serve content targeted to achieving the business goal of enrolling the user in a paperless delivery option. Further, in the subsequent evaluation of the condition in block 214 in this iteration, the system may determine not to establish orchestration for the user, because it was previously established in a prior iteration, and the No branch will be taken from block 214 to block 202.

FIG. 3 is a block diagram of a network environment 300 that includes a service provider system 330, according to certain exemplary implementations of the disclosed technology. The service provider system 330 (as will be discussed in more detail below with reference to FIG. 4) may include or be in communication with the account management system 320 (e.g., associated with a financial service provider) and an orchestration system 310. In certain implementations, the account management system 320 may store and/or have access to detailed customer information, such as identifying information, user context data, user profiles, mobile device data, and/or transaction data, for example. The account management system 320 in some examples is configured to process credit card transactions and account statements.

In accordance with certain exemplary embodiments, the account management system 320 is configured to receive or generate trigger events, which the orchestration system 310 evaluates with respect to targeted content deployment, as described and illustrated in detail above with reference to FIG. 2. While the orchestration system 310 and account management system 320 are illustrated in FIG. 3 as separate systems, the orchestration system 310 and account management system 320 can be integral with one another (e.g., with the orchestration system 310 being implemented as a module or application executed by the account management system 320). In other examples, the orchestration system 310 is coupled to the account management system 320 via the network 360 or another communications network and other configurations or network topologies can also be used in other examples.

In certain implementations, the mobile device 340 may be associated with a service provider customer (via the service provider system 330) and may host a service provider application 370 that is linked to the service provider system 330. The mobile device 340 may be a smart phone, tablet computer, smart wearable device, portable laptop computer, voice command device, wearable augmented reality device, or any other mobile computing device. The service provider application 370 can facilitate presentation of targeted content identified by the orchestration system 310, such as in response to a trigger event corresponding to a successful login via the service provider application 370.

The merchant POS terminal 350 may be associated with an entity such as a business, corporation, individual, partnership, or any other entity that may be a seller of goods and/or services. The merchant POS terminal 350 can communicate with the service provider system 330 via the network 360 to conduct a purchase transaction. Based at least in part on transaction data communicated by the merchant POS terminal 350, the orchestration system 310 can analyze the purchase history and other user context data for users that can inform the deployment of targeted content encouraging or facilitating enrollment in paperless delivery, as explained in more detail above.

The network 360 may be of any suitable type, including individual connections via the Internet such as cellular or WiFi networks. In some implementations, the network 360 may enable the communication(s) between the various systems and devices as depicted in FIG. 3. In some embodiments, the network 360 may connect with the mobile device 340 using available channels, including but not limited to: radio-frequency identification (RFID), near-field communication (NFC), Bluetooth™, low-energy Bluetooth™ (BLE), WiFi™, ZigBee™, ambient backscatter communications (ABC) protocols, USB, Ethernet, or LAN. In some embodiments, data can be transmitted across the network 360 in either an encrypted or un-encrypted format. The network 360 can comprise a mobile network interface that provides access to a cellular network, the Internet, or another wide-area network. In some embodiments, a mobile network interface may include hardware, firmware, and/or software that allows one or more processors to communicate with other devices via wired or wireless networks, whether local or wide area, private or public, as known in the art.

As described above, the orchestration system 310, account management system 320, and any of the other devices depicted in the network environment 300 may be configured to remotely communicate with one another and may include one or more of a microprocessor, microcontroller, digital signal processor, co-processor, memory, or the like or combinations thereof capable of executing stored instructions and operating upon stored data. The memory may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, hard disks, flash memory, a redundant array of independent disks (RAID), solid state drives (SSDs), and the like), for storing files including an operating system, application programs (including, for example, a web browser application or other applications, as necessary), executable instructions and data. In one embodiment, the processing techniques described herein are implemented as a combination of executable instructions and data within the memory.

The network environment 300 may include one or more storage devices configured to store information used by one or more processors (or other components) to perform certain functions related to the disclosed embodiments. In one example, the network environment 300 may include memory storing instructions to enable one or more processors to execute one or more applications, such as server applications, network communication processes, and any other type of application or software known to be available on computer systems. Alternatively, the instructions, application programs, etc. may be stored in an external storage or available from a memory over the network 360. The one or more storage devices may be volatile or non-volatile, magnetic, semiconductor, tape, optical, removable, non-removable, or other type of storage device or tangible, non-transitory computer-readable medium.

In one embodiment, the network environment 300 may include memory that includes instructions that, when executed by one or more processors (e.g., processors of one or more devices of the service provider system 330), perform one or more processes consistent with the functionalities disclosed herein. Methods, systems, and articles of manufacture consistent with disclosed embodiments are not limited to separate programs or computers configured to perform dedicated tasks.

The network environment 300 may also be communicatively connected to one or more memory devices (e.g., databases (not shown)) locally or through the network 360. The remote memory devices may be configured to store information and may be accessed and/or managed by the service provider system 330. By way of example, the remote memory devices may be document management systems, Microsoft® SQL databases, SharePoint® databases, Oracle® databases, Sybase™ databases, Postgres, MariaDB®, Couchbase™, Redis™, MongoDB® or other relational or non-relational databases. Systems and methods consistent with disclosed embodiments, however, are not limited to separate databases or even to the use of a database.

In exemplary embodiments of the disclosed technology, the network environment 300 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

In some embodiments, one or more web applications may be utilized by the network environment 300, for example, to interface with the mobile device 340. In certain implementations, the one or more web applications may include one or more web components. A rendered web component, for example, may be at least partially insulated from styles or variables that are defined outside of the web component, it can easily be copied and embedded in a wide variety of different types of code and applications, while preserving its general functionality. Web components may be programmed in a client-side programming language such as JavaScript, although this is not a requirement. Any suitable client-side programming language or software language can also be used.

FIG. 4 is a block diagram of the orchestration system 310 according to an exemplary implementation of the disclosed technology. The orchestration system 310 may have a similar structure and functions as depicted and described above with respect to FIG. 3. The orchestration system 310 may include a processor 410, an input/output (I/O) device 420, a memory 430 containing an operating system (OS) 440, a program 450, a machine learning model 460, and enrollment content database 470, and a customer information database 480. For example, the orchestration system 310 may be a single server or may be configured as a distributed computer system including multiple servers or computers that interoperate to perform one or more of the processes and functionalities associated with the disclosed embodiments. In some embodiments, the orchestration system 310 may further include a peripheral interface, a transceiver, a mobile network interface in communication with the processor 410, a bus configured to facilitate communication between the various components of orchestration system 310, and a power source configured to power one or more components of the orchestration system 310.

The processor 410 may be one or more known processing devices, such as a microprocessor from the Pentium family manufactured by Intel™ or the Turion™ family manufactured by AMD™. The processor 410 may constitute a single core or multiple core processor that executes parallel processes simultaneously. For example, the processor 410 may be a single core processor that is configured with virtual processing technologies. In certain embodiments, the processor 410 may use logical processors to simultaneously execute and control multiple processes. The processor 410 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

The orchestration system 310 may include or be in communication with one or more peripheral interfaces and may include the hardware, firmware and/or software that enables communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

According to an example implementation of the disclosed technology, orchestration system 310 includes a memory 430 that may store one or more programs 450 to perform one or more functions of the disclosed embodiments. The memory 430 may include one or more memory devices that store data and instructions used to perform one or more features of the disclosed embodiments. The memory 430 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 430 may include software components that, when executed by processor 410, perform one or more processes consistent with the disclosed embodiments.

While the orchestration system 310 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the orchestration system 310 may include a greater or lesser number of components than those illustrated.

### EXAMPLE USE CASE

The following example use case describes an example of a typical user flow pattern. This section is intended solely for explanatory purposes and not in limitation.

In one example, a user may login via a desktop computer to a web application hosted by a financial services provider with which the user has a credit account. Upon detecting the successful login event trigger, the orchestration system 310 determines that the user is not enrolled in paperless delivery of credit account statements and that orchestration has not been established for the user. Accordingly, the orchestration system 310 applies a stored machine learning model 460 to user context data obtained for the user from the customer information database 480. The user context data indicates that the user is a relatively frequent online shopper based on transaction history merchant and cadence data, is 30 years old, and has always paid his credit card bill online via the web application for the financial service provider.

The application of the machine learning model 460 yields a likelihood score of 95 (out of 100), which exceeds a predefined and stored configuration threshold likelihood score of 75. Accordingly, the orchestration system 310 retrieves targeted content from the enrollment content database 470 and provides it (or a link to the targeted content or an indication thereof) to the server (e.g., account management system 320) hosting the web application to which the user successfully logged in. The targeted content is a graphic with text and imagery that encourages enrollment in paperless statement delivery and indicates that clicking the graphic will facilitate enrollment via a hyperlink to an enrollment webpage of the web application. The targeted content is subsequently output via incorporation into a predefined location of a graphical user interface of the web application that is served following the successful login. The orchestration system 310 then determines that orchestration does not need to be established for the user because the likelihood score generated for the user was relatively high.

The user in this particular exemplary use case then selects the targeted content, submits a request to enroll in paperless delivery via another graphical user interface output following the selection, and the account management system 320 processes the request to update an indication in a record of the customer information database 480 for the user to indicate that the user is now enrolled in the paperless statement delivery option.

In some examples, disclosed systems or methods may involve one or more of the following clauses:

Clause 1: An orchestration system for content distribution, the orchestration system comprising: one or more processors; and memory in communication with the one or more processors and storing instructions that, when executed by the one or more processors, are configured to cause the orchestration system to: responsive to detecting an enrollment event based on an input received from a first user computing device, retrieve enrollment context data associated with a first user of the first user computing device; update a machine learning model based on the enrollment context data; responsive to detecting a trigger event associated with a second user, determine whether the second user is enrolled in a delivery option based on stored enrollment option data associated with the second user; responsive to determining the second user is not enrolled in the delivery option: obtain user context data associated with the second user; apply the machine learning model to the user context data to generate a likelihood score, wherein the likelihood score is indicative of a likelihood the second user will enroll in the delivery option following the trigger event; and responsive to determining the likelihood score exceeds a threshold, output first content to the second user, wherein the first content is identified based on a type of the trigger event.

Clause 2: The orchestration system of clause 1, wherein the instructions, when executed by the one or more processors, are further configured to cause the orchestration system to, responsive to determining the second user is not enrolled in the delivery option, determine whether automatic content delivery has been orchestrated for the second user based on stored orchestration data associated with the second user.

Clause 3: The orchestration system of clause 1, wherein the trigger event comprises a successful login via mobile or web application and a second user computing device associated with the second user, wherein the instructions, wherein the instructions, when executed by the one or more processors, are further configured to cause the orchestration system to insert the first content into a graphical interface output for display on the second user computing device after the successful login.

Clause 4: The orchestration system of clause 1, wherein the trigger event comprises an incoming phone call, wherein the first content comprises a prerecorded message, and wherein the instructions, when executed by the one or more processors, are further configured to cause the orchestration system to insert the first content as part of a hold message of an interactive voice response (IVR) automated phone system.

Clause 5: The orchestration system of clause 1, wherein the trigger event comprises generation of a statement for the second user and wherein the instructions, when executed by the one or more processors, are further configured to cause the orchestration system to incorporate the first content into the statement prior to printing the statement for subsequent distribution to the second user.

Clause 6: The orchestration system of clause 1, wherein the instructions, when executed by the one or more processors, are further configured to cause the orchestration system to, responsive to determining the likelihood score exceeds a threshold, generating and storing orchestration data associated with the second user, wherein the orchestration data comprises a content delivery sequence defining second content for automated output following subsequent trigger events associated with the second user.

Clause 7: The orchestration system of clause 6, wherein the instructions, when executed by the one or more processors, are further configured to cause the orchestration system to: apply the machine learning model to the user context data and synthetic data defining a plurality of synthetic trigger events to generate a plurality of likelihood scores, each for one of the synthetic trigger events, wherein the synthetic trigger events correspond to the subsequent trigger events; and generate the content delivery sequence based on a ranking of the likelihood scores.

Clause 8: The orchestration system of clause 1, wherein the instructions, when executed by the one or more processors, are further configured to cause the orchestration system to, responsive to detecting the trigger event associated with the second user: determine whether orchestration has been established for the second user based on stored orchestration data associated with the second user; responsive to determining orchestration has been established for the second user, determine whether the trigger event is next based on a content delivery sequence defined in the orchestration data and without determining whether the second user is enrolled in the delivery option; and responsive to determining the trigger event is next, output the first content to the second user.

Clause 9: The orchestration system of clause 1, wherein the instructions, when executed by the one or more processors, are further configured to cause the orchestration system to, responsive to determining the second user is not enrolled in the delivery option, or the likelihood score exceeds a threshold, output second content to the second user or bypass the trigger event.

Clause 10: The orchestration system of clause 1, wherein the first content is targeted to encourage enrollment in the delivery option by the second user.

Clause 11: The orchestration system of clause 1, wherein user context data for the second user comprises one or more of demographic data, historical or forecasted event data, historical statement data, transaction or purchase history data, or payment history data.

Clause 12: The orchestration system of clause 1, wherein the enrollment context data comprises other user context data for the first user and one or more of a type of another trigger event preceding the enrollment event, a time, date, or day of the week of the enrollment event, or a cadence of one or more other trigger events for the first user that preceded the enrollment event.

Clause 13: The orchestration system of clause 1, wherein the machine learning model is configured to correlate one or more portions of the enrollment context data and additional enrollment data for a plurality of other enrolled users with another one or more portions of the user context data to generate the likelihood score.

Clause 14: An orchestration system for content distribution, the orchestration system comprising: one or more processors; and memory in communication with the one or more processors and storing instructions that, when executed by the one or more processors, are configured to cause the orchestration system to: responsive to detecting a trigger event associated with a first user, determine whether the first user is enrolled in a delivery option based on stored enrollment option data associated with the first user; responsive to determining the first user is not enrolled in the delivery option: obtain user context data associated with the first user; apply a stored machine learning model to the user context data to generate orchestration data defining a delivery sequence for automated output of first content following subsequent trigger events associated with the first user, wherein the first content is targeted to encourage enrollment in the delivery option; and store the orchestration data associated with the first user.

Clause 15: The orchestration system of clause 14, wherein the instructions, when executed by the one or more processors, are further configured to cause the orchestration system to: responsive to detecting an enrollment event based on an input received from a user computing device, retrieve enrollment context data associated with a second user of the user computing device; and update the machine learning model based on the enrollment context data.

Clause 16: The orchestration system of clause 14, wherein the instructions, when executed by the one or more processors, are further configured to cause the orchestration system to: apply the stored machine learning model to the user context data and synthetic data defining a plurality of synthetic trigger events to generate a plurality of likelihood scores, each for one of the synthetic trigger events, wherein the synthetic trigger events correspond to the subsequent trigger events; and generate the content delivery sequence based on a ranking of the likelihood scores.

Clause 17: An orchestration system for content distribution, the orchestration system comprising: one or more processors; and memory in communication with the one or more processors and storing instructions that, when executed by the one or more processors, are configured to cause the orchestration system to: responsive to detecting a trigger event associated with a first user, determine whether the first user is enrolled in a delivery option based on stored enrollment option data associated with the first user; responsive to determining the first user is not enrolled in the delivery option: obtain user context data associated with the first user; apply a stored machine learning model to the user context data to generate a likelihood score, wherein the likelihood score is indicative of a likelihood the first user will enroll in the delivery option following the trigger event; and responsive to determining the likelihood score exceeds a threshold, output first content to the first user, wherein the first content is selected based on a type of the trigger event.

Clause 18: The orchestration system of clause 17, wherein the instructions, when executed by the one or more processors, are further configured to cause the orchestration system to: responsive to detecting an enrollment event based on an input received from a user computing device, retrieve enrollment context data associated with a second user of the user computing device; and update the machine learning model based on the enrollment context data.

Clause 19: The orchestration system of clause 17, wherein the instructions, when executed by the one or more processors, are further configured to cause the orchestration system to, responsive to determining the first user is not enrolled in the delivery option: generate orchestration data defining a delivery sequence for automated output of second content following subsequent trigger events associated with the first user, wherein the second content is targeted to encourage enrollment in the delivery option; and store the orchestration data associated with the first user.

Clause 20: The orchestration system of clause 17, wherein the machine learning model is configured to correlate one or more portions of the enrollment context data and additional enrollment data for a plurality of other enrolled users with another one or more portions of the user context data to generate the likelihood score.

Certain embodiments of the disclosed technology are described above with reference to block and flow diagrams of systems and methods and/or computer program products according to exemplary embodiments of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some embodiments of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a non-transitory computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the disclosed technology have been described in connection with what is presently considered to be the most practical and various embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An orchestration system for content distribution, the orchestration system comprising:
one or more processors; and
memory in communication with the one or more processors and storing instructions that, when executed by the one or more processors, are configured to cause the orchestration system to:
responsive to detecting an enrollment event based on an input received from a first user computing device, retrieve enrollment context data associated with a first user of the first user computing device;
update a machine learning model based on the enrollment context data;
responsive to detecting a trigger event associated with a second user, determine whether the second user is enrolled in a delivery option based on stored enrollment option data associated with the second user;
responsive to determining the second user is not enrolled in the delivery option:
obtain user context data associated with the second user;
apply the machine learning model to the user context data to generate a likelihood score, wherein the likelihood score is indicative of a likelihood the second user will enroll in the delivery option following the trigger event; and
responsive to determining the likelihood score exceeds a threshold, output first content to the second user, wherein the first content is identified based on a type of the trigger event.

2. The orchestration system of claim 1, wherein the instructions, when executed by the one or more processors, are further configured to cause the orchestration system to, responsive to determining the second user is not enrolled in the delivery option, determine whether automatic content delivery has been orchestrated for the second user based on stored orchestration data associated with the second user.

3. The orchestration system of claim 1, wherein the trigger event comprises a successful login via mobile or web application and a second user computing device associated with the second user, wherein the instructions, when executed by the one or more processors, are further configured to cause the orchestration system to insert the first content into a graphical interface output for display on the second user computing device after the successful login.

4. The orchestration system of claim 1, wherein the trigger event comprises an incoming phone call, wherein the first content comprises a prerecorded message, and wherein the instructions, when executed by the one or more processors, are further configured to cause the orchestration system to insert the first content as part of a hold message of an interactive voice response (IVR) automated phone system.

5. The orchestration system of claim 1, wherein the trigger event comprises generation of a statement for the second user and wherein the instructions, when executed by the one or more processors, are further configured to cause the orchestration system to incorporate the first content into the statement prior to printing the statement for subsequent distribution to the second user.

6. The orchestration system of claim 1, wherein the instructions, when executed by the one or more processors, are further configured to cause the orchestration system to, responsive to determining the likelihood score exceeds a threshold, generating and storing orchestration data associated with the second user, wherein the orchestration data comprises a content delivery sequence defining second content for automated output following subsequent trigger events associated with the second user.

7. The orchestration system of claim 6, wherein the instructions, when executed by the one or more processors, are further configured to cause the orchestration system to:
apply the machine learning model to the user context data and synthetic data defining a plurality of synthetic trigger events to generate a plurality of likelihood scores, each for one of the synthetic trigger events, wherein the synthetic trigger events correspond to the subsequent trigger events; and
generate the content delivery sequence based on a ranking of the likelihood scores.

8. The orchestration system of claim 1, wherein the instructions, when executed by the one or more processors, are further configured to cause the orchestration system to, responsive to detecting the trigger event associated with the second user:
determine whether orchestration has been established for the second user based on stored orchestration data associated with the second user;
responsive to determining orchestration has been established for the second user, determine whether the trigger event is next based on a content delivery sequence defined in the orchestration data and without determining whether the second user is enrolled in the delivery option; and
responsive to determining the trigger event is next, output the first content to the second user.

9. The orchestration system of claim 1, wherein the instructions, when executed by the one or more processors, are further configured to cause the orchestration system to, responsive to determining the second user is not enrolled in the delivery option, or the likelihood score exceeds a threshold, output second content to the second user or bypass the trigger event.

10. The orchestration system of claim 1, wherein the first content is targeted to encourage enrollment in the delivery option by the second user.

11. The orchestration system of claim 1, wherein user context data for the second user comprises one or more of demographic data, historical or forecasted event data, historical statement data, transaction or purchase history data, or payment history data.

12. The orchestration system of claim 1, wherein the enrollment context data comprises other user context data for the first user and one or more of a type of another trigger event preceding the enrollment event, a time, date, or day of the week of the enrollment event, or a cadence of one or more other trigger events for the first user that preceded the enrollment event.

13. The orchestration system of claim 1, wherein the machine learning model is configured to correlate one or more portions of the enrollment context data and additional enrollment data for a plurality of other enrolled users with another one or more portions of the user context data to generate the likelihood score.

14. An orchestration system for content distribution, the orchestration system comprising:
one or more processors; and
memory in communication with the one or more processors and storing instructions that, when executed by the one or more processors, are configured to cause the orchestration system to:
responsive to detecting a trigger event associated with a first user, determine whether the first user is enrolled in a delivery option based on stored enrollment option data associated with the first user;
responsive to determining the first user is not enrolled in the delivery option:
obtain user context data associated with the first user;
apply a stored machine learning model to the user context data to generate orchestration data defining a delivery sequence for automated output of first content following subsequent trigger events associated with the first user, wherein the first content is targeted to encourage enrollment in the delivery option; and
store the orchestration data associated with the first user.

15. The orchestration system of claim 14, wherein the instructions, when executed by the one or more processors, are further configured to cause the orchestration system to:
responsive to detecting an enrollment event based on an input received from a user computing device, retrieve enrollment context data associated with a second user of the user computing device; and
update the machine learning model based on the enrollment context data.

16. The orchestration system of claim 14, wherein the instructions, when executed by the one or more processors, are further configured to cause the orchestration system to:
apply the stored machine learning model to the user context data and synthetic data defining a plurality of synthetic trigger events to generate a plurality of likelihood scores, each for one of the synthetic trigger events, wherein the synthetic trigger events correspond to the subsequent trigger events; and
generate the content delivery sequence based on a ranking of the likelihood scores.

17. An orchestration system for content distribution, the orchestration system comprising:
one or more processors; and
memory in communication with the one or more processors and storing instructions that, when executed by the one or more processors, are configured to cause the orchestration system to:
responsive to detecting a trigger event associated with a first user, determine whether the first user is enrolled in a delivery option based on stored enrollment option data associated with the first user;
responsive to determining the first user is not enrolled in the delivery option:
obtain user context data associated with the first user;
apply a stored machine learning model to the user context data to generate a likelihood score, wherein the likelihood score is indicative of a likelihood the first user will enroll in the delivery option following the trigger event; and
responsive to determining the likelihood score exceeds a threshold, output first content to the first user, wherein the first content is selected based on a type of the trigger event.

18. The orchestration system of claim 17, wherein the instructions, when executed by the one or more processors, are further configured to cause the orchestration system to:
responsive to detecting an enrollment event based on an input received from a user computing device, retrieve enrollment context data associated with a second user of the user computing device; and
update the machine learning model based on the enrollment context data.

19. The orchestration system of claim 17, wherein the instructions, when executed by the one or more processors, are further configured to cause the orchestration system to, responsive to determining the first user is not enrolled in the delivery option:
generate orchestration data defining a delivery sequence for automated output of second content following subsequent trigger events associated with the first user, wherein the second content is targeted to encourage enrollment in the delivery option; and
store the orchestration data associated with the first user.

20. The orchestration system of claim 17, wherein the machine learning model is configured to correlate one or more portions of the enrollment context data and additional enrollment data for a plurality of other enrolled users with another one or more portions of the user context data to generate the likelihood score.
